(19) United States
(12) Patent Application Publication
(10) Pub. No.: US 2019/0031472 A1
(43) Pub. Date: Jan. 31, 2019

(54) ROOF ARRANGEMENT FOR AN ELEVATOR CAR

(71) Applicant: KONE Corporation, Helsinki (FI)

(72) Inventor: Tero Salin, Helsinki (FI)

(73) Assignee: KONE Corporation, Helsinki (FI)

(21) Appl. No.: 16/146,690

(22) Filed: Sep. 28, 2018

Related U.S. Application Data
(63) Continuation of application No. PCT/FI2016/050361, filed on May 25, 2016.

(51) Int. Cl. B66B 11/02; E05D 3/18; E05D 15/42

(52) U.S. Cl. CPC B66B 11/0226; E05D 3/18; E04B 9/003; E05Y 2900/104; E05D 15/42

(57) ABSTRACT

In a roof arrangement for an elevator car in an elevator, the elevator car including an untreated roof, walls and a ceiling hinged to the untreated roof, the ceiling is hinged to the untreated roof of the elevator car with a hinge mechanism including an articulation mechanism that is arranged to pull the first end of the ceiling away from the wall of the elevator car at the same time as the second end of the ceiling is turned downwards.

The object of the invention is a roof arrangement for an elevator car as defined in the preamble of claim 1.

The roof arrangement for an elevator car according to the invention is particularly well suited to cover the interior untreated roof of the elevator car with a visually decorative ceiling, which is fixed to the untreated roof in a hinged manner in such a way that the free edge of the ceiling can be easily lowered downwards by means of a hinge arrangement, in which case access opens to the elevator devices that are above the ceiling.

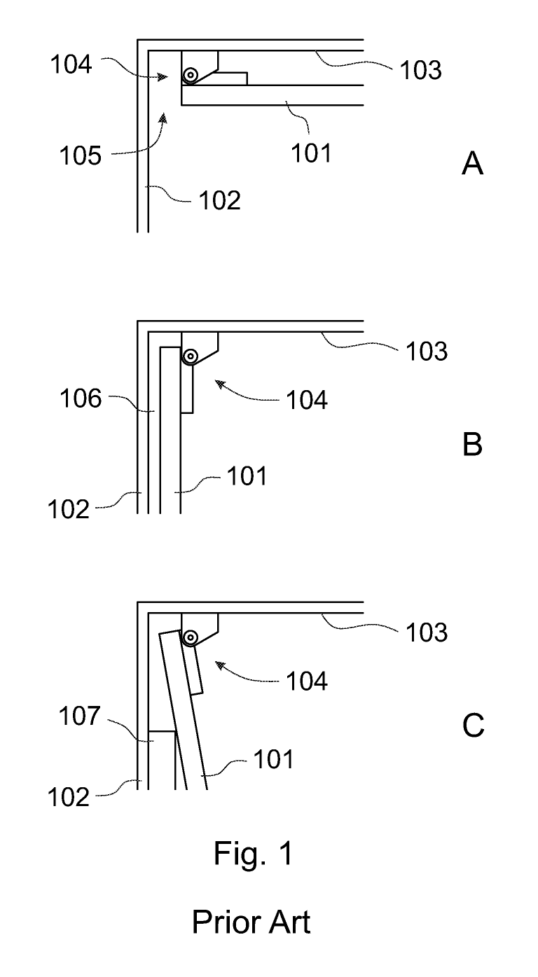

In prior-art hinge arrangements for the ceiling of an elevator car, ordinary hinges are generally used with which the ceiling is fastened to the untreated roof of the elevator car. One such solution is presented in FIG. 1, wherein the aspects A-C describe different situations. In situation A of FIG. 1 the untreated roof 103 of the elevator car is covered with a ceiling 101, which is fixed to the untreated roof 103 by means of an ordinary hinge arrangement 104 in such a way that in its upper position the nearest edge of the ceiling 101 is at a distance 105 from the inside surface of the wall 102 of the elevator car. In the situation B of FIG. 1 the ceiling 101 of the elevator car has been turned downwards around the hinge of the hinge arrangement 104. Only a very narrow gap 106 remains between the downward-turned ceiling 101 and the wall 102. If there are surface-mounted components on the wall 102, e.g. the call button panel 107 presented in the situation C of FIG. 1, the ceiling 101 cannot necessarily be lowered down properly if the distance 105 of the hinge arrangement from the wall 102 is not sufficiently large. A problem in this solution is that is precisely that the distance 105 must be extremely large for the turning downwards of the ceiling to properly succeed. This makes it difficult to modify the outward appearance of the gap between the ceiling 101 and the top part of the wall 102. In addition, the solution presented by FIG. 1 does not allow the use of a thick ceiling, which would have e.g. rounded corners and edges improving its appearance.

The aim of the present invention is to eliminate the aforementioned drawbacks and achieve an inexpensive and easy-to-implement roof arrangement for an elevator car, in which the ceiling covering the untreated roof can be situated closer to the inside surface of the wall of the elevator car than solutions known in the art. The roof arrangement for an elevator car according to the invention is characterized by what is disclosed in the characterization part of claim 1. Other embodiments of the invention are characterized by what is disclosed in the other claims.

Some inventive embodiments are also discussed in the descriptive section of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. Likewise the different details presented in connection with each embodiment can also be applied in other embodiments. In addition it can be stated that at least some of the subordinate claims can in at least some situations be deemed to be inventive in their own right.

One of the advantages, among others, that can be achieved by means of the invention is that owing to the ease of turning it downwards the solution enables easy and quick access to the devices on the roof of the elevator car that are covered by the decorative ceiling. The arrangement according to the invention enables an effective solution also structurally and visually, which efficiently hides the untreated car from view. A smaller gap than in prior art between the hinge-side edge of the ceiling and the wall of the elevator car enables good visual modifiability between the edges of the ceiling and the top edges of the surface panels of the walls of the elevator car, in which case e.g. the aforementioned gap can be hidden better and more easily than present-day solutions. In addition, e.g. rounded inside corners can easily be made in the ceiling, which corners improve the visual appearance of the ceiling. One advantage is also that the solution according to the invention enables a thicker ceiling structure than at present. Yet another advantage is that the ceiling when turned down does not strike any components surface-mounted on the wall, such as call button panels, railings or lights, because when turning the ceiling downwards it simultaneously shifts farther away from the hinge-side wall.

In the following, the invention will be described in more detail by the aid of an example of its embodiment with reference to the simplified and diagrammatic drawings attached, wherein

FIG. 1 presents a side view of one solution according to prior art in one top corner of the elevator car,

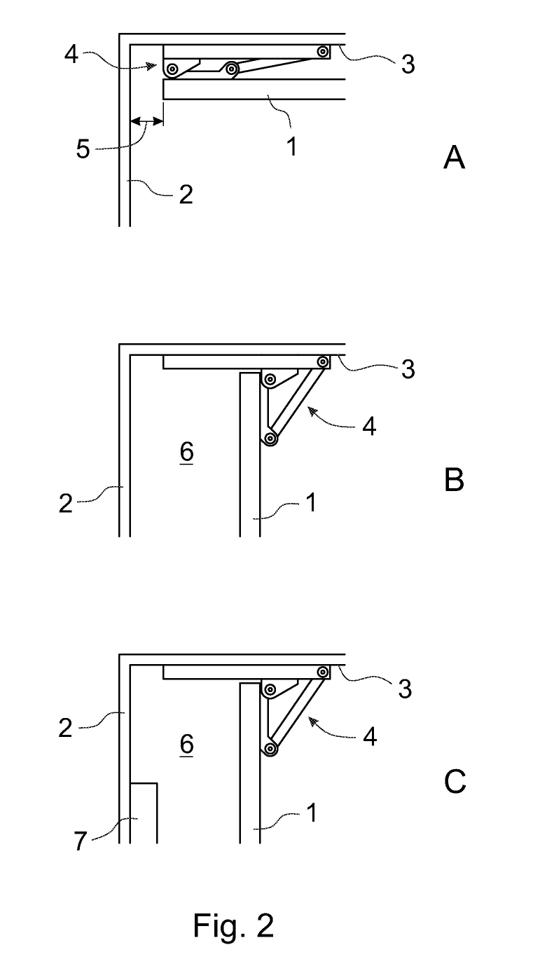

FIG. 2 presents a side view of one solution according to the invention in one top corner of the elevator car,

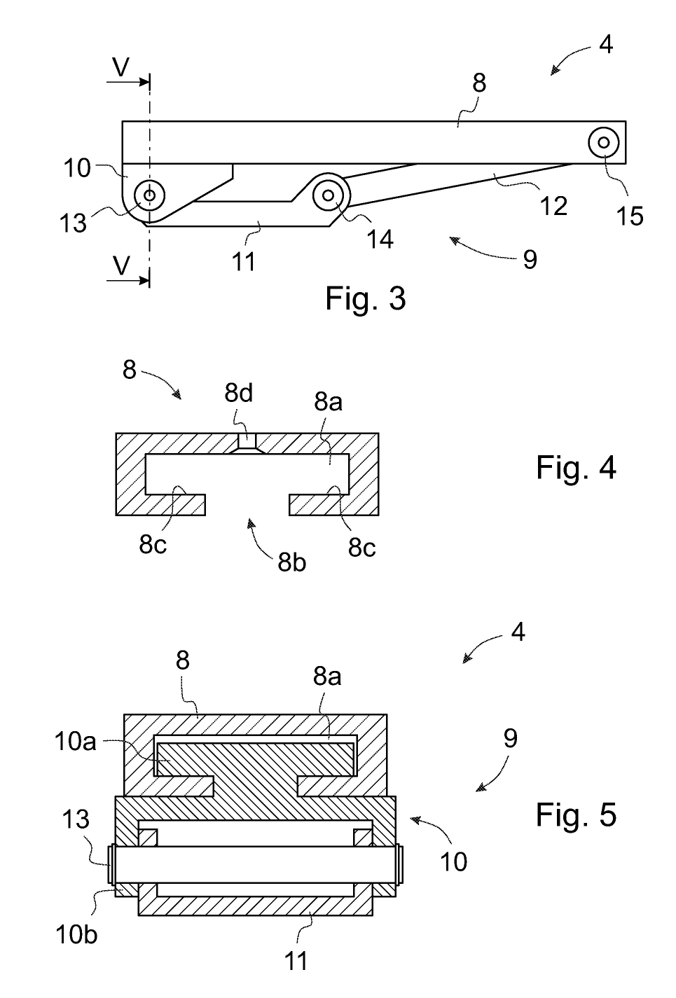

FIG. 3 presents a side view of the hinge mechanism to be used in the arrangement according to the invention for fastening the ceiling to the inside surface of the untreated roof of the elevator car,

FIG. 4 presents a sectioned end view of the frame part of the aforementioned hinge mechanism,

FIG. 5 presents the hinge mechanism according to FIG. 3 as viewed from the end and sectioned along the line V-V of FIG. 3,

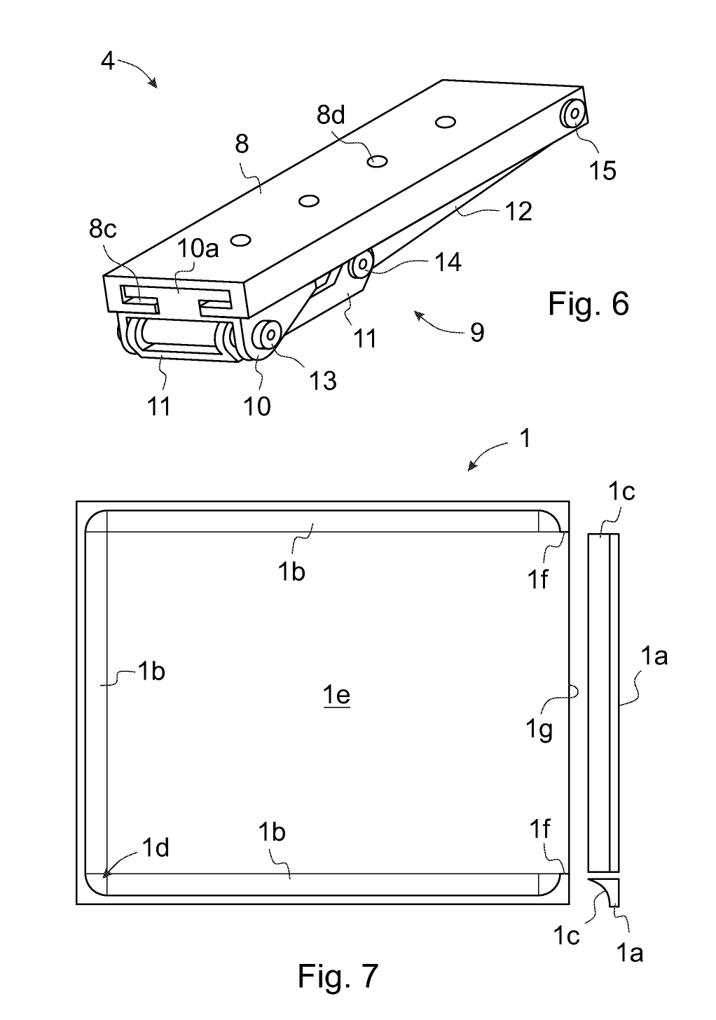

FIG. 6 presents an oblique view from the top and side of the hinge mechanism according to FIG. 3,

FIG. 7 presents one ceiling used in the arrangement according to the invention as viewed from below, and also the support beading of the free edge of the ceiling as viewed from below and from the end of the support beading,

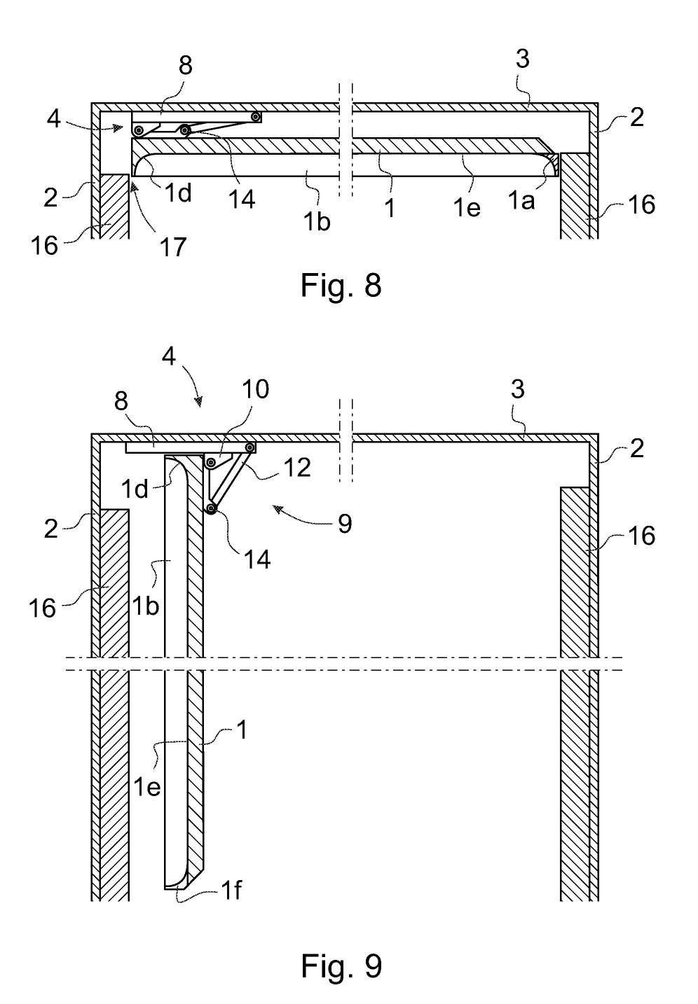

FIG. 8 presents a sectioned side view of the top part of the elevator car when provided with one ceiling structure belonging to the arrangement according to the invention, in the situation in which the ceiling is in its upper position, and

FIG. 9 presents a sectioned side view of the top part of the elevator car according to what is presented in

FIG. 8 in a situation in which the ceiling is turned into its downward position.

FIG. 2 presents a diagrammatic, simplified and sectioned view of one roof arrangement for an elevator according to the invention. Of the roof arrangement, FIG. 2 presents a side view of only one top corner of the elevator car.

In situation A of FIG. 2 the untreated roof 3 of the elevator car is covered with a ceiling 1, which is fixed to the untreated roof 3 by means of a hinge mechanism 4 according to the invention in such a way that in its upper position the nearest edge of the ceiling 1 is at a distance 5 from the inside surface of the first wall 2 of the elevator car. In situation B of FIG. 2 the ceiling 1 of the elevator car has been turned down around the hinge axis of the hinge of the hinge mechanism 4. A sufficiently wide gap 6 now remains between the downward-turned ceiling 1 and the inside surface of the first wall 2 because, owing to the construction and functioning of the hinge mechanism 4, when turning the ceiling 1 downwards the hinging point simultaneously moves away from the inside surface of the aforementioned wall 2, towards the center part of the elevator car. The ceiling 1 is farthest from the inside surface of the wall 2 when said ceiling is turned 90° downwards, as in the situation B of FIG. 2. In the situation C of FIG. 2 it is seen that a component 7, such as e.g. a car call panel, surface-mounted on the wall 2 is sufficiently far away in the horizontal direction from the turned-down ceiling 1, and does not therefore cause any problem in relation to the ceiling 1.

In FIGS. 3-6 the hinge mechanism 4 to be used in the arrangement according to the invention is presented in more detail. In FIG. 3 as viewed from the side, in FIG. 5 as viewed from the end and sectioned along the line V-V of FIG. 3, and in FIG. 6 obliquely from above and from the side. In addition,

FIG. 4 presents an end view of the frame part 8 of the hinge mechanism 4, cross-sectioned at the point of one fixing hole 8d.

The hinge mechanism 4 comprises at least an elongated frame part 8 and articulation mechanism 9, which comprises a sliding part 10 that is shorter than the frame part 8, a fixing part 11 and two parallel transmission rods 12 of fixed length, as well as hinge axes, i.e. hinge pins 13, 14 and 15. The frame part 8 is a slab-shaped profile element, the top surface of which is planar and in the center of the bottom surface of which is a groove 8b of essentially the whole length of the frame part in length, which groove extends into the hollow inside space 8a of the frame part 8. The frame part 8 is e.g. a rectangular square hollow section in cross-sectional profile, with both internal and external corners being right angles. On the bottom surface of the hollow inside part 8a of the frame part 8, on both sides of the groove 8b, is a slide surface 8c in the longitudinal direction of the frame part 8, for facilitating movement of the sliding part 10. In addition, in the frame part 8 is a plurality of fixing holes 8d for fixing the hinge mechanism 4 e.g. to the untreated roof 3 of the elevator car.

The sliding part 10 of the hinge mechanism 4 is situated at the first end of the frame part 8 and comprises at least a suspension part 10a and a support part provided with fixing lugs 10b, said support part being attached to the suspension part 10a. Preferably on the bottom surface of the suspension part 10a are slide surfaces, which correspond to the slide surfaces 8c of the frame part 8 when the sliding part 10 is disposed inside the frame part 8. In addition, in the fixing lugs 10b of the support part are holes for the hinge axis 13, i.e. for a hinge pin, by means of which the fixing part 11 is hinged at its first end to the sliding part 10. Correspondingly, the fixing part 11 is hinged at its second end to the first ends of the transmission rods 12 by means of a hinge axis 14 or by means of two separate joints. At their second ends the transmission rods 12 are hinged to the second end of the frame part 8 by means of a hinge axis 15 or by means of two separate joints. The hinge axis 15 forms a pivot of the transmission rods 12, the pivot being immobile in the horizontal and vertical directions and being referred to also with the reference number 15. In the fixing part 11 are fixing holes, by means of which the hinge mechanism 4 is fixed to the first end of the ceiling 1 of the elevator car to support, in turn, the ceiling 1 of the elevator car. Depending on the size of the elevator car and on the size of the hinge mechanism 4, there can be one or more hinge mechanisms 4 in the support of the ceiling 1.

The hinge mechanism 4 according to the invention has three different joints, hinge axes or also pivots 13, 14 and 15 in the horizontal direction, of which the first pivot 13 is arranged to move in essentially only in the horizontal direction, the third pivot 15 is immobile and the second pivot 14, which is between the first pivot 13 and the third pivot 15 in the horizontal direction, is arranged to move in both the vertical and the horizontal direction when the second end of the ceiling 1 is turned downwards or upwards.

FIG. 7 presents one ceiling 1 used in the arrangement according to the invention as viewed from below, and also the support beading 1a of the free end of the ceiling 1 as viewed from below and from the end of the support beading 1a.

The ceiling 1 presented in FIG. 7 is thinner in its middle part 1e than its edges, in which case the ceiling 1, when it is in place in its upper position, resembles an upside-down rectangular basin that has essentially thick edges, the inside corners of the basin having a rounding 1d and the inside edges of the basin having a rounding 1b. The support beading 1a has a rounding 1c corresponding to the roundings 1b of the inside edges. The roundings 1b-1d are e.g. a decoration softening the visual appearance. It is possible to use also other forms of decoration for the lower surface of the ceiling 1.

The center part 1e of the ceiling 1 forms an essentially flat surface that continues up to the edge 1g of the second end of the ceiling 1. The thicker edge section on the edge 1g of the second end of the ceiling 1 ends in both corners in a flat surface 1f at the end of the corner rounding 1d, in which case the distance remaining between the aforementioned flat surfaces 1f is dimensioned to correspond to the length of the support beading 1a in such a way that the support beading 1a can be disposed between the flat surfaces 1f for keeping the ceiling 1 in place in its upper position. The cross-sectional profile of the support beading 1a corresponds to the profile of the end edge of the ceiling 1 at the point of the flat surfaces 1f, so that when the ceiling 1 is in place in the upper position on top of the support beading 1a, the curved shape 1b of the top corner of the edge continues essentially the same from one corner to the other corner of the second end of the ceiling 1.

FIGS. 8 and 9 present a side view of the sectioned top part of the elevator car when provided with one ceiling structure belonging to the arrangement according to the invention. In the situation according to FIG. 8, the ceiling 1 is in its upper position and in the situation according to Fog. 9 the ceiling 1 is turned into its downward position. In both figures the elevator car is sectioned in the vertical plane in such a way that only the top corners of the elevator car are visible. Additionally, in FIG. 9 the elevator car is sectioned also in the horizontal plane in such a way that the free end of the turned-down ceiling 1 is visible.

When the ceiling 1 is in place in the upper position it is fixed at its first end by means of the hinge mechanism 4 to the untreated roof 3 of the elevator car and at its second end the ceiling 1 is supported on the support beading 1a, which support beading 1a is fixed e.g. to the surface structure 16 of the second wall 2 of the elevator car, such as to a wall panel or corresponding, or through a surface panel 16 to the second wall 2 of the elevator car.

The ceiling 1 is dimensioned in shape and size to be such that, when it is in place in its upper position, between the outside edges of the ceiling 1 and the surface structure 16 of the walls is a narrow and essentially dark gap 17, through which people inside the elevator car cannot see the other roof structures behind the ceiling 1.

When the ceiling 1 is turned downwards, first the support beading 1a is detached, after which the free end of the ceiling 1 is turned downwards guided by the hinge mechanism 4. Owing to the construction of the hinge mechanism 4, the downward-turnable ceiling 1 pulls the second end of the fixing part 11 downwards along with it, in which case the sliding part 10, which cannot move downwards, slides inside the frame part 8 towards the second end of the frame part 8 and away from the first wall 2 of the elevator car, towards the center part of the elevator car, taking at the same time the first end of the ceiling 1, said end being hinged to the sliding part 10, away from the first wall 2 of the elevator car. This pulling away results from the fixed-dimension transmission rods 12, the position of which changes as the hinge axis 14 of the fixing part 11 displaces downwards. When the ceiling 1 has been lowered downwards in the situation according to FIG. 9, the ceiling 1 is far enough away from the first wall 2 of the elevator car, from the surface structure 16 of said wall and also from possible surface-mounted components 7.

When the necessary servicing work or corresponding has been completed, the ceiling 1 is turned upwards back into position, the support beading 1a is fixed into position under the ceiling 1 and the ceiling 1 is lowered into position to rest on the support beading 1a. After this the elevator car is ready to be taken into normal operation.

It is obvious to the person skilled in the art that the invention is not limited solely to the examples described above, but that it may be varied within the scope of the claims presented below. Thus, for example, the hinge mechanism of the ceiling can also be other than what is presented above. What is essential is that the hinge mechanism takes the ceiling away from the wall of the elevator car at the same time as the ceiling is turned downwards.

It is also obvious to the skilled person that the hinge axis at the second end of the transmission rods, which axis forms an pivot of the transmission rods, the pivot being immobile in the horizontal and vertical directions, can be also elsewhere than at the second end of the frame part of the hinge mechanism. It can, for example, be fixed directly to the untreated roof of the elevator car.

1. A roof arrangement for an elevator car in an elevator, the elevator car including an untreated roof, walls and a ceiling hinged to the untreated roof,
wherein the ceiling is hinged to the untreated roof of the elevator car with a hinge mechanism comprising an articulation mechanism that is arranged to pull the first end of the ceiling away from the wall of the elevator car at the same time as the second end of the ceiling is turned downwards.

2. The arrangement according to claim 1, wherein the hinge mechanism comprises a frame part to be fixed to the untreated roof of the elevator car and an articulation mechanism, the articulation mechanism comprising a sliding part that is shorter than the frame part, a fixing part fixed at a first end thereof in an articulated manner to the sliding part, and at least one transmission rod fixed at a first end thereof in an articulated manner to the fixing part, the second end of the transmission rod being fixed in an articulated manner to a pivot that is vertically and horizontally immobile.

3. The arrangement according to claim 1, wherein the first end of the ceiling is fixed in an articulated manner to the sliding part of the hinge mechanism, said sliding part moving essentially in the horizontal direction.

4. The arrangement according to claim 1, wherein the movable sliding part of the hinge mechanism is fixed to the first end of the ceiling via the fixing part, the fixing part being in turn connected in an articulated manner by means of fixed-length transmission rods to a pivot that is vertically and horizontally immobile.

5. The arrangement according to claim 1, wherein the sliding part is arranged to be supported on the frame part and to slide inside the frame part towards the center part of the elevator car when turning the ceiling downwards around the hinge axis that is in the sliding part.

6. The arrangement according to claim 1, wherein the sliding part is arranged to be supported on the frame part and to slide inside the frame part away from the center part of the elevator car when turning the ceiling upwards around the hinge axis that is in the sliding part.

7. The arrangement according to claim 1, wherein the hinge mechanism has three different pivots in the horizontal direction, of which the first pivot is arranged to move in essentially only in the horizontal direction, the second pivot is arranged to move in both the vertical and the horizontal direction and the third pivot is immobile.

8. The arrangement according to claim 7, wherein the second pivot is between the first pivot and the third pivot in the horizontal direction, and it is arranged to move in both the vertical and the horizontal direction when the second end of the ceiling is turned downwards or upwards.

9. The arrangement according to claim 2, wherein the first end of the ceiling is fixed in an articulated manner to the sliding part of the hinge mechanism, said sliding part moving essentially in the horizontal direction.

10. The arrangement according to claim 2, wherein the movable sliding part of the hinge mechanism is fixed to the first end of the ceiling via the fixing part, which fixing part is in turn connected in an articulated manner by means of fixed-length transmission rods to a pivot that is vertically and horizontally immobile.

11. The arrangement according to claim 3, wherein the movable sliding part of the hinge mechanism is fixed to the first end of the ceiling via the fixing part, which fixing part is in turn connected in an articulated manner by means of fixed-length transmission rods to a pivot that is vertically and horizontally immobile.

12. The arrangement according to claim 2, wherein the sliding part is arranged to be supported on the frame part and to slide inside the frame part towards the center part of the elevator car when turning the ceiling downwards around the hinge axis that is in the sliding part.

13. The arrangement according to claim 3, wherein the sliding part is arranged to be supported on the frame part and to slide inside the frame part towards the center part of the elevator car when turning the ceiling downwards around the hinge axis that is in the sliding part.

14. The arrangement according to claim 4, wherein the sliding part is arranged to be supported on the frame part and to slide inside the frame part towards the center part of the elevator car when turning the ceiling downwards around the hinge axis that is in the sliding part.

15. The arrangement according to claim 2, wherein the sliding part is arranged to be supported on the frame part and to slide inside the frame part away from the center part of the elevator car when turning the ceiling upwards around the hinge axis that is in the sliding part.

16. The arrangement according to claim 3, wherein the sliding part is arranged to be supported on the frame part and to slide inside the frame part away from the center part of the elevator car when turning the ceiling upwards around the hinge axis that is in the sliding part.

17. The arrangement according to claim 4, wherein the sliding part is arranged to be supported on the frame part and to slide inside the frame part away from the center part of the elevator car when turning the ceiling upwards around the hinge axis that is in the sliding part.

18. The arrangement according to claim 5, wherein the sliding part is arranged to be supported on the frame part and to slide inside the frame part away from the center part of the elevator car when turning the ceiling upwards around the hinge axis that is in the sliding part.

19. The arrangement according to claim 2, wherein the hinge mechanism has three different pivots in the horizontal direction, of which the first pivot is arranged to move in essentially only in the horizontal direction, the second pivot is arranged to move in both the vertical and the horizontal direction and the third pivot is immobile.

20. The arrangement according to claim 3, wherein the hinge mechanism has three different pivots in the horizontal direction, of which the first pivot is arranged to move in essentially only in the horizontal direction, the second pivot is arranged to move in both the vertical and the horizontal direction and the third pivot is immobile.
